(19) United States
(12) Patent Application Publication
(10) Pub. No.: US 2009/0144237 A1
(43) Pub. Date: Jun. 4, 2009

(54) METHODS, SYSTEMS, AND COMPUTER PROGRAM PRODUCTS FOR PROVIDING PERSONALIZED MEDIA SERVICES

(76) Inventors: Michael Branam, Lawrenceville, GA (US); Timothy H. Weaver, Alpharetta, GA (US)

Correspondence Address: AT&T Legal Department - CC;Attn: Patent Docketing, Room 2A-207, One AT&T Way, Bedminster, NJ, 07921, US

(21) Appl. No.: 11/948,750

(22) Filed: Nov. 30, 2007

(51) Int. Cl. G06F 7/10; G06F 17/30; G06F 3/00

(52) U.S. Cl. 707/3; 725/39; 707/E17.014

(57) ABSTRACT

Methods, systems, and computer program products for implementing personalized media services are provided. A method includes receiving log-in credentials and addressing data for an electronic commerce website and assigning a combined device identifier and personal information number (PIN) code to an account record. The combined device identifier and PIN code uniquely identifies an individual associated with the log-in credentials. The method also includes mapping the combined device identifier and PIN code to the log-in credentials within the account record. In response to receiving a request for information, the method includes searching the electronic commerce website for data matching an element of the request and presenting results of the search to a device associated with the device identifier.

### BACKGROUND

The present application relates generally to electronic transactions, and more particularly, to methods, systems, and computer program products for implementing personalized media services over a network.

Various types of communications devices have become ubiquitous in today's marketplace. It is not uncommon for a single individual to now own and operate multiple electronics and/or communications devices that serve differing purposes. For example, an individual may utilize a wireline telephone in the home, in addition to a cellular telephone and/or a personal digital assistant (PDA) operating over a wireless cellular network for use when the individual is away from home. In addition, most individuals in the United States now own multiple television sets in the home, which may be Internet enabled (e.g., IPTV). For example, many households now have televisions throughout the home, e.g., living room, recreation room, bedrooms, and/or kitchen. This may be, in part, because of the increasing affordability of televisions, as well as the diverse programming content available today.

With regard to television advertising, many viewers have become increasingly inundated with a wide variety of advertisements, as evidenced by the increasing demand for personal recording devices. While consumers are not generally opposed to advertising, per se, they may object to the volume of these advertisements, which interrupt programming at inopportune times from the viewpoint of the audience. Thus, the timing of an advertisement can be important; that is, presenting the right advertisement at the right time. By contrast, online purchasing is becoming more prevalent, due in part to its convenience. That is, a consumer who accesses a business' website for product information is more likely to be ready to make a purchase. As a result, many enterprises have now set up online catalogs through a dedicated website to induce sales. Over time, as television advertising becomes more ineffective, advertisers will have to seek new ways to push product information to consumers.

What is needed, therefore, is a way to provide personalized media services over a network.

### BRIEF SUMMARY

Exemplary embodiments include methods for implementing electronic transactions. A method includes receiving log-in credentials and addressing data for an electronic commerce website and assigning a combined device identifier and personal information number (PIN) code to an account record. The combined device identifier and PIN code uniquely identifies an individual associated with the log-in credentials. The method also includes mapping the combined device identifier and PIN code to the log-in credentials within the account record. In response to receiving a request for information, the method includes searching the electronic commerce website for data matching an element of the request and presenting results of the search to a device associated with the device identifier.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of a system upon which electronic transactions and event-driven marketing activities may be implemented in exemplary embodiments;

FIG. 2 is a flow diagram describing a process for implementing the electronic transactions in exemplary embodiments;

FIG. 3 illustrates a sample mapping of combined device identifiers and personal identification numbers (PINs) to an electronic commerce account in exemplary embodiments;

FIG. 4 is a display screen of a media device including a user interface screen for initiating an electronic transaction in exemplary embodiments;

FIG. 5 is a display screen depicting a personalized electronic programming guide set up menu and electronic wallet in exemplary embodiments;

FIG. 6 is a flow diagram describing a process for implementing event-driven marketing activities in exemplary embodiments;

FIG. 7 is a display screen illustrating a sample interactive purchase window provided via the event-driven marketing activities in exemplary embodiments;

FIG. 8 is a block diagram of a system upon which personalized composite channel services, personalized electronic traffic reporting services, customized communication channels, personalized media file libraries, and personalized electronic programming guides may be implemented in exemplary embodiments;

FIG. 9 is a flow diagram illustrating a process for implementing the personalized composite content services in exemplary embodiments;

FIGS. 10-12 are display screens provided via the personalized composite content services in exemplary embodiments;

FIG. 13 is a flow diagram describing a process for implementing the personalized electronic traffic reporting services in exemplary embodiments;

FIG. 14 is a display screen for creating a personalized electronic traffic report in exemplary embodiments;

FIG. 15 is a flow diagram describing a process for implementing the personalized electronic programming guide (EPG) services in exemplary embodiments;

FIG. 16 is a display screen for creating a personalized electronic programming guide in exemplary embodiments;

FIG. 17 is a flow diagram describing a process for implementing the customized communications channel services in exemplary embodiments;

FIG. 18 is a display screen illustrating a sample customized communications channel in exemplary embodiments;

FIG. 19 is a flow diagram describing a process for implementing the personalized media file library services in accordance with exemplary embodiments; and

FIG. 20 is a display screen illustrating a sample personalized media file library in exemplary embodiments.

The detailed description explains the exemplary embodiments, together with advantages and features, by way of example with reference to the drawings.

### DETAILED DESCRIPTION OF EXEMPLARY EMBODIMENTS

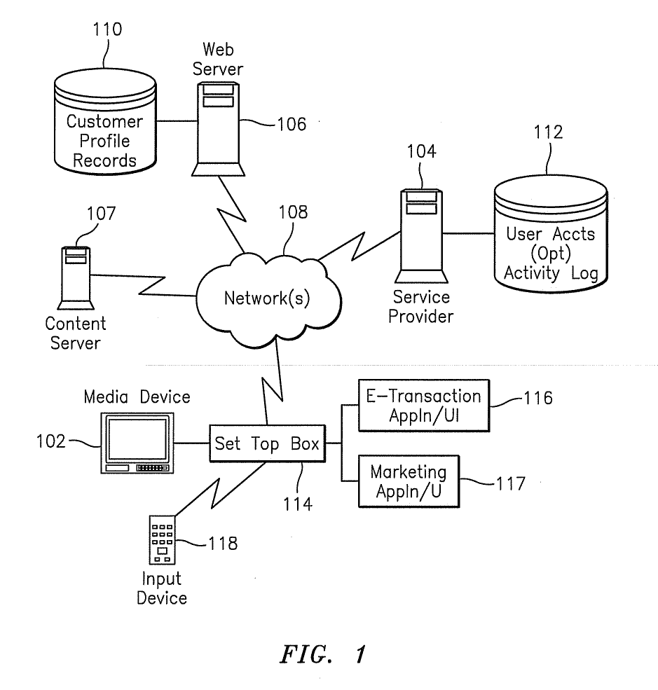

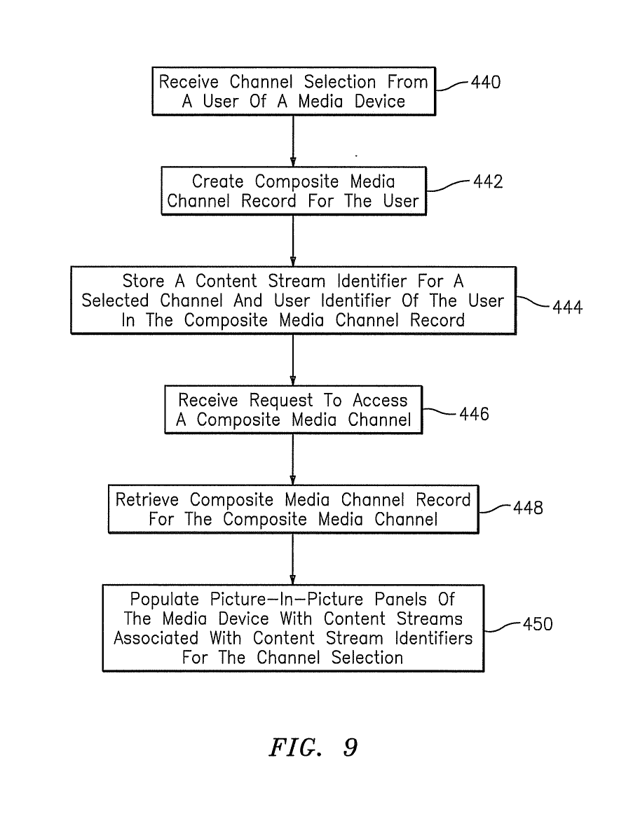

Media and media device-related services are provided in accordance with exemplary embodiments. The types of services that may be provided include, e.g., electronic transactions, event-driven marketing activities, personalized composite channels, customized communication channels, personalized electronic traffic reporting, personalized media file libraries, and personalized electronic programming guides. The electronic transaction services are described in greater detail in FIGS. 1-5. The event-driven marketing activities are described in greater detail in FIGS. 1, 6, and 7. The personalized composite channel services are described in greater detail in FIGS. 8 through 12. The personalized electronic traffic reporting services are described in further detail in FIGS. 8, 13, and 14. The personalized electronic programming guides are described in further detail in FIGS. 8, 15, and 16. The customized communication channels are described in further detail in FIGS. 8, 17, and 18. The personalized media file library services are described in further detail in FIGS. 8, 19, and 20.

Turning now to FIG. 1, a portion of a system upon which the electronic transactions services and the event-driven marketing services may be implemented will now be described. The system of FIG. 1 includes a media device (also referred to herein as “device”) 102, service provider system 104, web server 106, and a content server 107, each of which are in communication with one or more networks 108. In an exemplary embodiment, the media device 102 may be an Internet Protocol-enabled television (IPTV). The media device 102 is communicatively coupled to a set top box (STB) 114. In alternative exemplary embodiments, the media device 102 and STB 114 are integrally configured (e.g., as a single device).

As shown in FIG. 1, the service provider system 104 is in communication with the media device STB 114 via the networks 108. The service provider system 104 provides programming services, such as broadcast and/or Internet-based content programming, to its customers, e.g., a user of the media device 102. The service provider system 104 is in communication with a storage device 112 as will be described further herein.

The web server 106 is also in communication with the media device STB 114 via the networks 108. The web server 106 may be an electronic commerce enterprise that provides goods and services to its customers via, e.g., a dedicated website. The web server 106 may provide these goods and services through an online electronic catalog or similar means. In addition, the web server 106 is in communication with a storage device 110, which may store the electronic product catalogs, as well as customer profile records that contain information about customers who purchase goods and services from the electronic commerce enterprise. In addition, the web server 106 may store purchase information including payment options (e.g., mode of payment for goods and services).

Each of the web server 106 and service provider system 104 may be implemented using a high-speed processing device (e.g., a computer system) that is capable of handling high volume activities conducted via communications devices (e.g., the media device STB 114), as well as via related network entities.

The content server 107 is in communication with the media device 102, via the service provider system 104 over the networks 108. The content server 107 may be implemented at a video head end office (VHO), regional video services office (VSO) or other source of content that distributes programming, news, and/or gaming on a local, national, or international basis. While only one content server 107 is shown for ease of illustration, it will be understood that the content server 107 may be one of many content servers in communication with the network system of FIG. 1. These content servers 107 may provide a variety of content over an IP-based network. The content may include premium channels, broadcast programming, and Internet-based matter. The content provided by the content servers 107 may include, e.g., news, sports, weather, business, shopping, traffic, and/or stocks, and may provide a range of content types, such as health and fitness, documentaries, comedy, science fiction, action/adventure, horror, romance, and/or drama, over IP-based network. In addition, the enterprise of the content server 107 may be a business partner of the electronic commerce website of the web server 106 (e.g., website of the web server 106 is www.discoverychannel.com, and the content server 107 is the Discovery Channel).

In exemplary embodiments, the media device STB 114 includes a computer processor. Alternatively, if integrated with the media device 102, the combined media device 102 and STB 114 may implement a computer processor. The computer processor executes applications for implementing the electronic transaction services and event-driven marketing services. These applications are referred to herein as the e-transaction application 116, and the marketing application 117, respectively. In exemplary embodiments, a user of the media device 102 establishes an account that is managed by the applications 116 and 117. Alternatively, management of the account may be shared by the applications 116, 117 and a network entity (e.g., the service provider system 104). For example, authentication procedures and market profiles related to the account may be managed by the service provider system 104. The authentication procedures and market profiles are described further herein. Account records for the accounts identify each of the media devices belonging to a community of users (e.g., household) and provide other information as described herein. Account records may be stored in memory at the media device STB 114 and/or at an external network entity, such as the web server 106 (in the storage device 110) or the service provider system 104 in the storage device 112. While only a single media device 102 is shown in FIG. 1, it will be understood that multiple media devices may be implemented and associated with a single user or a community of users (e.g., household members). One or more of the media devices may be co-located in a customer premises.

The system of FIG. 1 also includes an input device 118 in communication with the STB 114. The input device 118 may be a wireless remote control device that enables a user of the media device 102 to interact with the applications 116, 117.

The networks 108 may employ various wireless communications and transmissions protocols, such as personal communications service (PCS), WiFi, Ultrawideband, Bluetooth, and satellite transmission, as well as different wireline protocols, such as telephone communications, cable communications and power line communications, to name a few.

Referring now to FIGS. 1-5, the electronic transaction services will now be described in further detail. According to exemplary embodiments, the electronic transaction services provide targeted advertising, information, and purchase opportunities to a user of the media device 102 in a manner that is least disruptive to ongoing programming. The advertising, information, and purchase opportunities are targeted to a specific individual based upon criteria, such as viewing activities conducted via the media device 102 and profile information relating to the user that matches various market profiles defined for a campaign. The electronic transaction application 116 enables this type of ‘profiling’ utilizing the account record that identifies an individual logged into the application 116, as well as the viewing activities of the individual as described further herein.

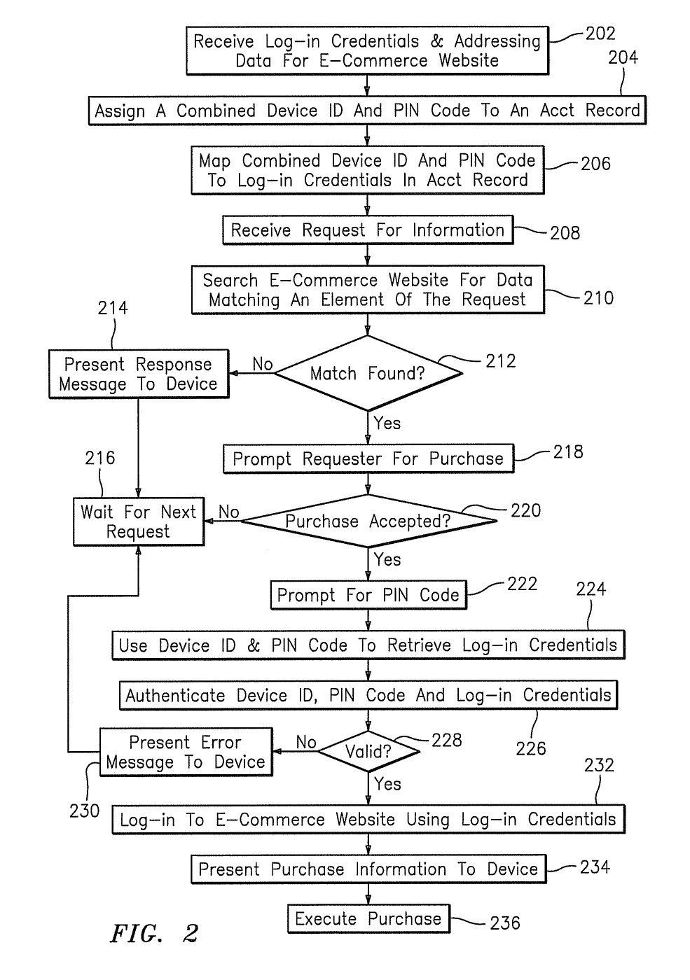

FIG. 2 is a flow diagram describing a process establishing an account for the user and for implementing an electronic transaction between the user and an electronic commerce enterprise (e.g., the web server 106) in accordance with exemplary embodiments. Steps 202-206 are directed to establishing a user account or adding a new user to an existing account. Steps 208-236 are directed to conducting an electronic transaction via the account.

At step 202, the user of the media device 102 enters log-in credentials for the website of the web server 106 (e.g., a user name and password that the electronic commerce enterprise uses to authenticate the user to its website-website user account). The user may optionally enter addressing data for the website (e.g., a uniform resource locator). The e-transaction application 116 includes a user interface that guides the user (via a display screen on the media device 102) to enter this information. The options provided by the user interface may be selected via input features and functions (e.g., up/down, left/right arrow keys, ‘select’ key, etc.) provided on the media device 102 and/or input device 118 using, e.g., the input device 118.

At step 204, the e-transaction application 116 assigns a device identifier and personal identification number (PIN) code of the user to an account record. The device identifier identifies the media device (as well as household) through which the user is providing the account set up information. For example, the device identifier may be, e.g., a globally unique identifier (GUID), MAC address, and/or serial number, assigned to the media device STB 114 at the time of manufacture. This information may be readily ascertained by the e-transaction application 116 without user input. For example, the STB 114 associated with the media device 102 may be configured to send the unique device identifier (e.g., GUID, MAC address, serial number, etc.) to the e-transaction application 116. The PIN code refers to a unique numeric or alphanumeric character string (e.g., 4-digits) that identifies the individual at the media device 102. Other account users (e.g., family members) that share media devices may create their own unique PIN codes. Thus, the combined device identifier and PIN code may identify not only a household for which the device identifier is assigned via the account, but also the identity of each individual in the household. Further, upon entering the unique PIN code at the time of program viewing at the device, the e-transaction application 116 may track the viewing activities (e.g., channel surfing) conducted by the viewer.

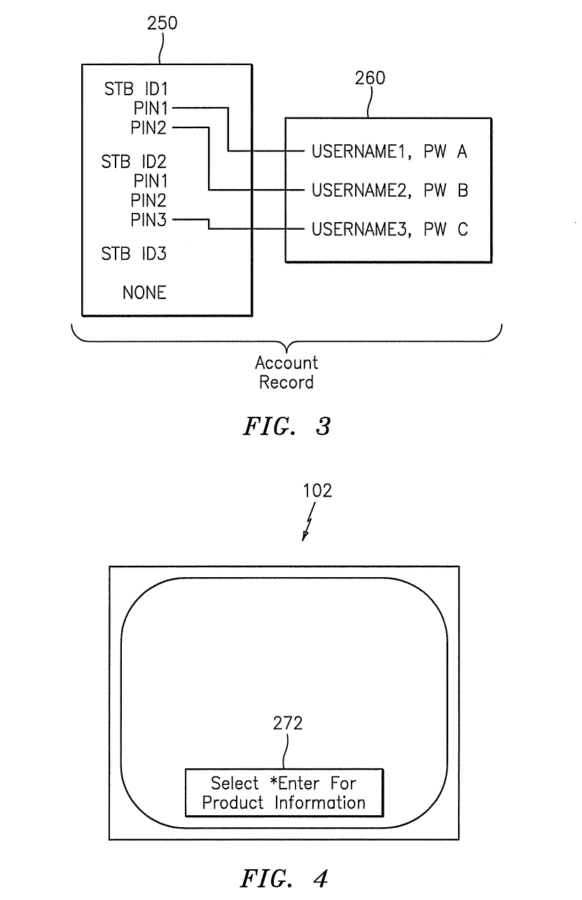

At step 206, the combined device identifier and PIN code are mapped to the user's log-in credentials in the account record. A sample mapping of a record containing combined device identifiers and PIN codes to a record of user log-in credentials for an account record is shown in FIG. 3. As shown in FIG. 3, a record 250 lists each device identifier (STB ID#) for each media device in the account (e.g., household). For each device identifier, there may be multiple PIN codes, each of which identifies an individual user of the account (e.g., PIN#). Also, as shown in FIG. 3, these combined device identifiers and PIN codes are mapped to corresponding log-in credentials (e.g., USERNAME#, PW#) in a record 260. As indicated above, the log-in credentials are specific to an individual with respect to an electronic commerce enterprise. It will be understood that additional information may be stored in the account record, such as account values and balances, as will be described further herein.

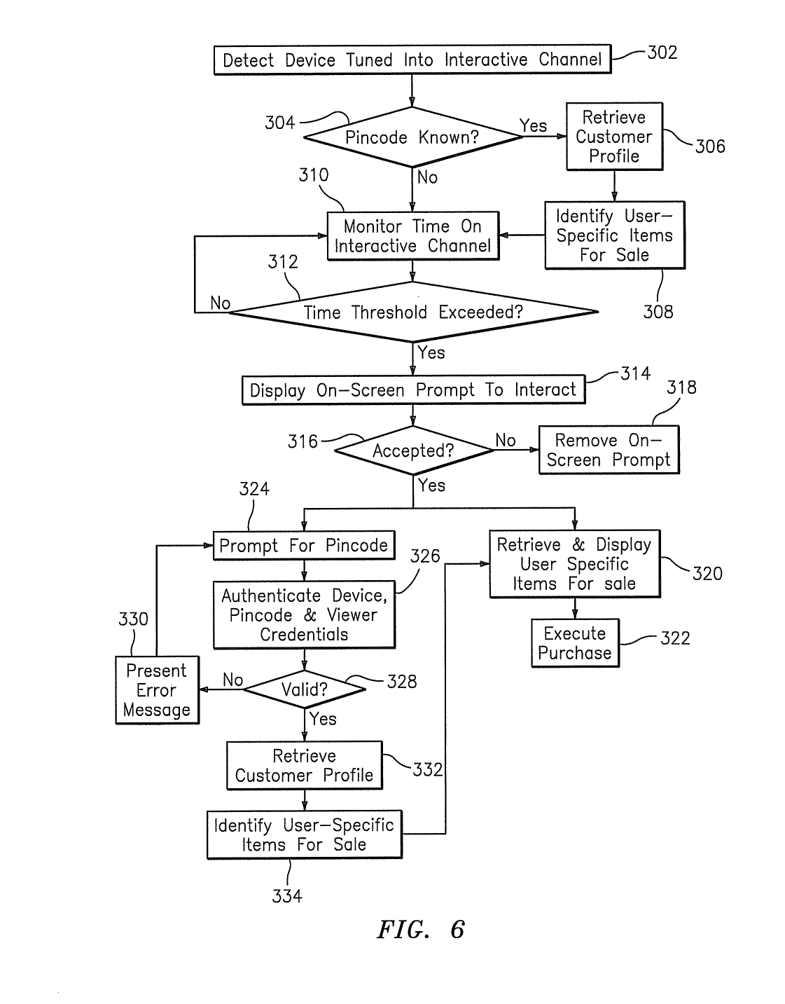

Once the account record is created, a user with maximum defined access control privileges (e.g., head of household, parent, etc.), as configured via the e-transaction application 116, may manage other users established in the account as shown and described, e.g., in FIG. 5.

In addition, once the account record is established, it may be stored, e.g., in the STB 114 or external authentication system on the network 108, and users listed in the account may initiate an electronic transaction as described in steps 208-236 of FIG. 2. Returning to FIG. 2, it is assumed that the media device 102 is tuned into an interactive channel (e.g., IPTV channel originating from the content server 107). While not necessary to realize the advantages of the exemplary embodiments, the channel may be a shopping channel, such as QVC® or HSN®. Alternatively, the channel may be a standard interactive programming channel that also sells merchandise online (e.g., Discovery®). If the user enters addressing data for the interactive channel (e.g., as described in step 202), the e-transaction application 116 may identify and access the corresponding website for the channel when the user tunes in to the channel.

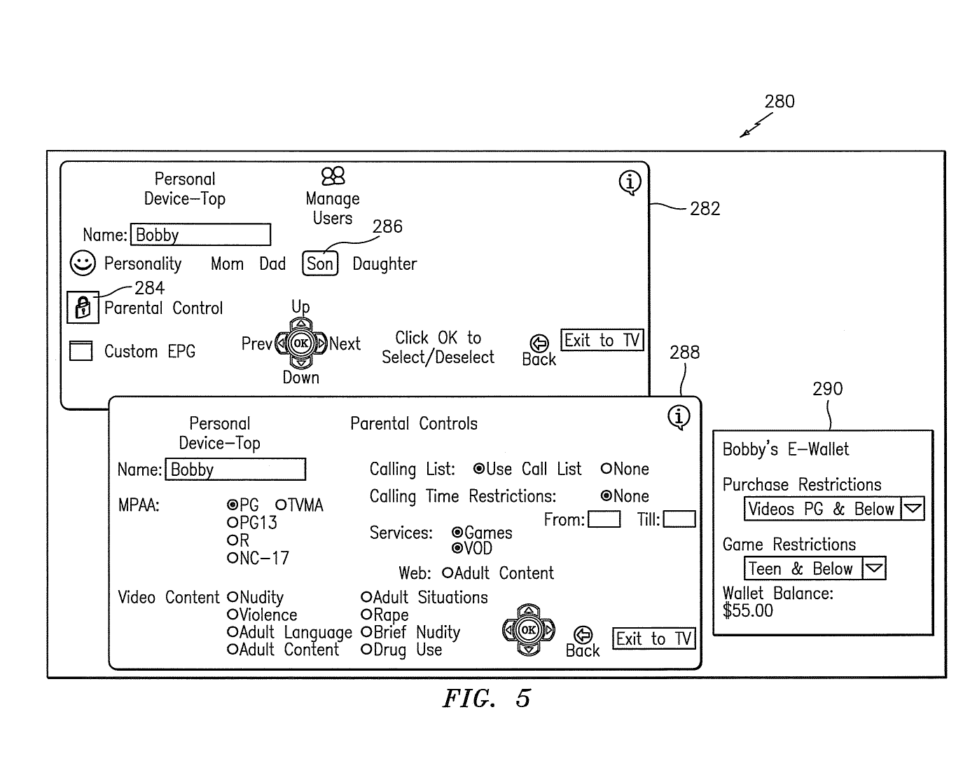

At step 208, the e-transaction application 116 receives a request for information from the user (e.g., via the input device 118). The request may be implemented by a user interface screen provided by the e-transaction application 116. As shown in FIG. 4, a sample display screen on the media device 102 includes a pop-up window 272 guiding the user in obtaining product information. Once the user responds to the prompt (e.g., enters *ENTER), the e-transaction application 116 user interface may present additional prompts, such as a listing of products and/or topics that relate to the programming currently active via the channel on the media device 102. In response to the request, the e-transaction application 116 searches the electronic commerce website (e.g., the web server 106) or other network entity (e.g., via a search engine type tool) for data matching an element (e.g., search term or string) of the request at step 210.

At step 212, it is determined whether a match was found. If not, a response message is presented on the display of the media device 102 indicating that the search was unsuccessful at step 214. This may be due to, e.g., a product subject to the search being sold out. In this instance, the e-transaction application 116 waits for the next user request at step 216. On the other hand, if a match is found, the e-transaction application 116 prompts the user to purchase the item resulting from the search at step 218. Again, this may be implemented by the user interface component of the e-transaction application 116 via the display on the media device 102.

If the purchase is not accepted by the user at step 220, the e-transaction application 116 waits for the next request at step 216. If, however, the purchase is accepted by the user at step 220, the e-transaction application 116 prompts the user for a PIN code at step 222. This step may be optional where the user has previously entered a PIN code (e.g., at the beginning of the programming viewing). The e-transaction application 116 receives the PIN code and uses the combined device identifier and PIN code to retrieve the user log-in credentials from the account record at step 224. The combined device identifier and PIN code and the log-in credentials are authenticated at step 226. The authentication may be performed by the e-transaction application 116 or by another network entity, such as the service provider system 104.

If the authentication performed in step 226 is unsuccessful (e.g., invalid entry) at step 228, an error message is presented to the user via the media device 102 display at step 230 and the e-transaction application 116 waits for the next user request at step 216. Otherwise, if the entries are valid at step 228, the e-transaction application 116 uses the log-in credentials of the user to log in to the website (e.g., the web server 106) at step 232. The e-transaction application 116 presents purchase information from the website on the media device 102 at step 234 and executes the purchase at step 236. The purchase information may include payment options (e.g., credit card information), shipping information, total costs, etc. If the user has previously purchased goods from the website, the electronic commerce enterprise may have a record of these purchases, including bank/credit card information, user name, and/or address. In this instance, the bank/credit information, user name, and/or address may be displayed on the media device 102 for confirmation by the user prior to finalizing the purchase. Once the purchase has been accepted, the e-transaction application 116 may execute a purchase order for the purchase and transmit the purchase order to the website.

If the purchase is for a media file or other non-tangible product, the purchase may be executed by downloading the media file to the media device 102 or to another device specified by the user. As used herein, the term “media file” shall refer to any representation of media content, such as a transmitted or stored audio signal, video signal, or image signal, for example. In exemplary embodiments, the media file is a video media file. In another embodiment, the media file is a near real-time video media file. As used herein, the term “near-real time” shall refer to a nearly contemporaneous transmission and delivery of the media file, and that such delivery may include small delays as a result of transfer among multiple transmission paths.

As described above, the account record may include additional information, such as an account value and balance. The e-transaction application 116 may include a feature that enables an account holder to establish a monetary fund for each account user via the PIN code for each user. The monetary fund may be a financial account that is linked to the account holder's bank account and to each of the account users in the account record as desired by the account holder. This feature, referred to herein as ‘e-wallet’, allows a user in the account to purchase goods/services via the e-transaction application 116, which in turn, provides an updated account balance for each user upon completion of a purchase transaction. The e-wallet feature may be implemented as part of a personalized electronic programming guide, which is described further in FIGS. 8, 15, and 16. An exemplary user interface screen 280 for establishing an e-wallet for a user is shown in FIG. 5.

The user interface screen 280 of FIG. 5 depicts a personalized electronic programming guide set up menu and e-wallet in exemplary embodiments. The personalized electronic programming guide provides an account holder with the ability to manage account users via windows 282 and 288. As shown in the window 282, the account holder has identified the user to be managed as “Son” 286. The account holder then selects a Parental Control option 284 which causes the window 288 to be presented. In the window 288, the account user enters the name of the son and selects various controls to be implemented as shown in the window 288. In a window 290, once the monetary account or personal fund has been established for the user, the account holder may set restrictions on the purchase activities conducted by the user (i.e., Bobby) during activities transpiring via the interactive channel to which the media device 102 is tuned. As shown in the window 290, the e-transaction application 116 may also provide a balance on the monetary account established for the user.

As indicated above, event-driven marketing activities may be implemented for users of the account. The event-driven marketing activities provide marketing information that is targeted to an individual viewer's tastes and preferences. According to exemplary embodiments, the marketing application 117 monitors and logs viewing activities by the user of the media device 102 and, based upon the occurrence of an event, e.g., an amount of time spent tuned into an interactive channel, the marketing application 117 prompts the user to interact with the marketing application 117, which may result in a product sale. The marketing application 117 may capture viewer information, such as the types of programming content the viewer has interest in (e.g., personal preferences or interests), as well as the viewing habits (e.g., particular time of day, number of hours, etc. a viewer is watching television). This information may be facilitated, e.g., using the combined device identifier and PIN code, as well as the interactive activities conducted by the viewer (e.g., purchasing activities using the log-in credentials).

According to exemplary embodiments, a user interface component of the marketing application 117 guides the user to enter information into the media device STB 114 via the input device 118. The marketing application 117 may employ the same authentication procedures as those described in FIGS. 1-3 above. To this extent, a description of these procedures will be omitted.

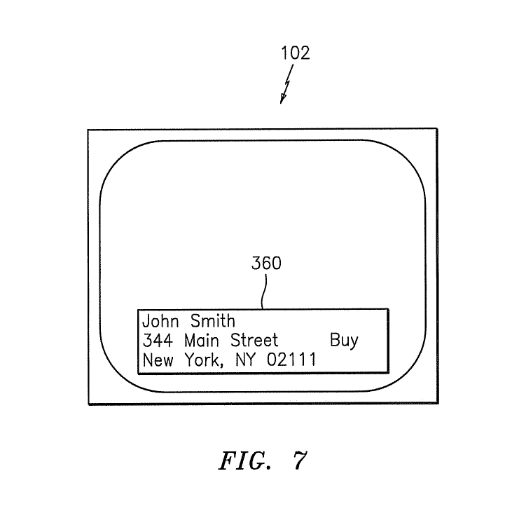

Turning now to FIG. 6, a flow diagram describing a process for implementing the event-driven marketing activities will now be described in exemplary embodiments. The marketing application 117 includes a tracking/monitoring component that identifies an interactive channel (e.g., an IP-enabled program originating from the content server 107) to which the media device 102 is tuned, and may include a timer for tracking the amount of time the media device 102 is tuned to the channel. At step 302, the marketing application 117 detects a media device (e.g., the media device 102) tuned into an interactive channel. At step 304, the marketing application 117 checks to see if a PIN code for the viewer at the media device 102 is known (e.g., whether the viewer logged in with the PIN code before watching the program). If so, the marketing application 117 retrieves a customer profile for the user (e.g., name, age, gender, address) at step 306. The customer profile may be established as, e.g., a registration event performed upon installation of the media device set top box 114.

At step 308, the marketing application 117 identifies user-specific items for sale based, in part, upon the products available via the interactive channel. Determining which items to present to the viewer for sale may be implemented by identifying a marketing profile for the viewer and mapping the viewing activities of the viewer and the marketing profile to corresponding items for sale. The marketing profile specifies characteristics of a group targeted for an advertising/marketing campaign. For example, if the customer profile for the viewer indicates that the subject viewer is 35 years old and male, and the viewing activities indicate that the subject viewer frequently watches sports on ESPN®, as well as programming on the SCI-FI® channel, a marketing profile directed to this demographic is identified and used to select specific items available for purchase (e.g., sports gear, science fiction DVDs). The viewing activities may be logged by the marketing application 117 in order to assess the viewer's personal preferences. In determining the viewer's preferences, criteria such as an amount of time the media device 102 is tuned into the interactive channel may be taken into account. In addition, or alternatively, a frequency in which the media device 102 is tuned into a specified program presented via the interactive channel may be considered. Further, other criteria, such as various interactions conducted by the viewer at the media device 102 (e.g., purchase transaction history with, e.g., the web server 106) may be considered in determining the viewer's preferences. The marketing profile may be received and stored directly in the STB 114, or may be managed by an external network entity, such as the web server 106 or service provider system 104.

Turning back to step 304, if the PIN code is not known or the marketing application 117 identifies user-specific items for sale based upon the products available via the interactive channel at step 308, the marketing application 117 monitors the amount of time the media device 102 is tuned into the interactive channel at step 310. The marketing application 117 may be configured to define a threshold time value that is used as a trigger event. If the time threshold has not been exceeded at step 312, the process returns to step 310 and the marketing application 117 continues to monitor the time in which the device 102 is tuned into the interactive channel. Otherwise, if the time threshold has been exceeded, the marketing application 117 displays a prompt on the display of the media device 102 to interact at step 314.

If the user does not accept in response to the prompt at step 316, the on-screen prompt is removed from the display screen at step 318 and the programming proceeds as normal. Otherwise, if the user accepts the prompt to interact at step 316, then one of two courses of actions may be taken. For example, if the PIN code has been previously established at step 304, then the process will proceed with steps 320 and 322. However, if the PIN code was not previously established from step 304, then the course of action directed to steps 324-334 is taken.

For example, if the PIN code has been previously established at step 304, then once the user accepts the prompt to interact at step 316, the marketing application 117 retrieves and displays user-specific items for sale at step 320 (as described above with respect to step 308), and the purchase is executed at step 322.

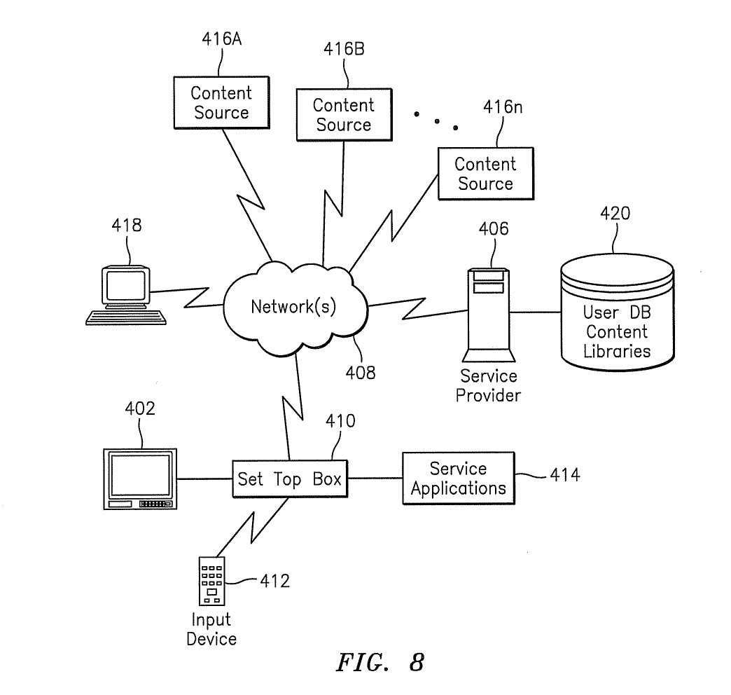

Alternatively, if the PIN code has not been previously established from step 304, and the user has accepted the prompt to interact at step 316, the marketing application 117 prompts the user for a PIN code at step 324. At step 326, the device identifier, PIN code, and viewer log-in credentials are authenticated (as described in FIGS. 1-3). If the authentication fails (e.g., invalid entry) at step 328, an error message is presented on the display of the media device 102 at step 330, and the process returns to step 324. Otherwise, if the authentication is successful, the marketing application 117 retrieves the customer profile for the user at step 332, and identifies user-specific items for sale at step 334. The process continues to steps 320 and 322 as described above. As shown in FIG. 7, the media device 102 includes a display screen in which a window 360 is presented. The purchase execution may be implemented by presenting the customer profile (e.g., from the storage device 110 of the web server 106 as customer profile records) to the user via the media device 102 where the user confirms the profile information and selects “BUY.” Alternatively, the customer profile information may be stored on the media device 102 and transmitted to the web server 106. The purchase information may be processed in a manner similar to that described in FIGS. 1-3.

As described above with respect to the e-transaction application 116, a personal fund (also referred to as ‘personal fund account’) may be established by a master account holder for one or more users listed in the account record using the e-wallet feature. The e-wallet feature may be accessed directly, e.g., via a personalized electronic programming guide or by selecting a function on the input device 118. The e-wallet feature may also provide account balances on the display of the media device 102 upon the completion of an electronic purchase.

As indicated above, various additional services may be implemented, such as personalized composite channel services, personalized electronic traffic reporting services, customized communication channels, personalized media file libraries, and personalized electronic programming guides.

The personalized composite channel services enable a user to customize the presentation of media content based upon viewer preferences and, optionally, based upon a size of the display screen of a media device. In particular, the user may select multiple video content streams for simultaneous viewing on the media device. The personalized electronic traffic reporting services enable a user to create a customized or personal electronic traffic report where multiple picture-in-picture panels of a media device are populated with live Internet Protocol-based video feeds associated with the Internet Protocol addresses of the video feeds for simultaneous viewing. The customized communication channel services enable a user to define a community of users of media devices and provide customized content to members of the community of users. The personalized media file library services enable a user to create a personalized media file library and receive updates to the library as new media files are discovered. The personalized electronic programming guide services enable a user to customize the presentation of programming content within a personal, user-specific electronic programming guide.

FIG. 8 is a block diagram of a system upon which personalized composite channel services, personalized electronic traffic reporting services, customized communication channels, personalized media file libraries, and personalized electronic programming guides may be implemented in exemplary embodiments.

The system of FIG. 8 includes network entities 402, 406, 416A through 416n, and 418. The network entity 402 is a media device (also referred to herein as “device”). In an exemplary embodiment, the media device 402 is an Internet Protocol-enabled television (IPTV). In a further exemplary embodiment, the media device 402 is picture-in-picture (PIP)-enabled. The network entity 406 is a service provider system. The media device 402, service provider system 406, and networks 408 are similar to the corresponding media device 102, service provider system 104, and networks 108, respectively, of FIG. 1. To this extent, these entities will not be further described. The network entities 416A through 416n represent content sources. For example, the sources of content 416A-416n may include video broadcast content, IP-based video content, IP-based radio content, IP-enabled video camera content, RSS transmitted text feeds, media file sources (e.g., podcasts), and non-commercial IP-based content sources as will be described further herein. The network entity 418 may be a personal computer device. Each of the network entities 402, 406, 416A through 416n, and 418 may be in communication with one or more of the networks 408. The media device 402 is communicatively coupled to a set top box (STB) 410. In alternative exemplary embodiments, the media device 402 and STB 410 are integrally configured (e.g., as a single device).

As shown in FIG. 8, the service provider system 406 is in communication with the media device STB 410 via the networks 408. The service provider system 406 provides programming services to its customers, e.g., a user of the media device 402. The service provider system 406 is in communication with a storage device 420 as will be described further herein.

The service provider system 406 may be implemented using a high-speed processing device (e.g., a computer system) that is capable of handling high volume activities conducted via communications devices (e.g., the media device STB 410), as well as via related network entities.

The networks 408 may employ various wireless communications and transmissions protocols, such as personal communications service (PCS), WiFi, Ultrawideband, Bluetooth, and satellite transmission, as well as different wireline protocols, such as telephone communications, cable communications and power line communications, to name a few.

In exemplary embodiments, the media device STB 410 includes a computer processor. The computer processor executes applications for implementing service applications 414. According to exemplary embodiments, these service applications 414 include a composite media application, a traffic application, a media application, a programming guide application, and a custom communication application. In exemplary embodiments, a user of the media device 402 establishes an account that is managed by the applications 414. Alternatively, management of the account may be shared by the applications 414 and a network entity (e.g., the service provider system 406). For example, authentication procedures, community content records, media file libraries, and log files may be managed by the service provider system 406. The authentication procedures, community content records, media file libraries, and log files are described further herein.

Files stored on the media device STB 410 may include composite media records, log files, composite media traffic records, personalized EPGs, community content records, and media file records/libraries. Alternatively, some or all of these files may be stored at an external network entity, such as the service provider system 406.

The system of FIG. 8 also includes an input device 412 in communication with the STB 410. The input device 412 may be a wireless remote control device that enables a user of the media device 402 to interact with the service applications 414.

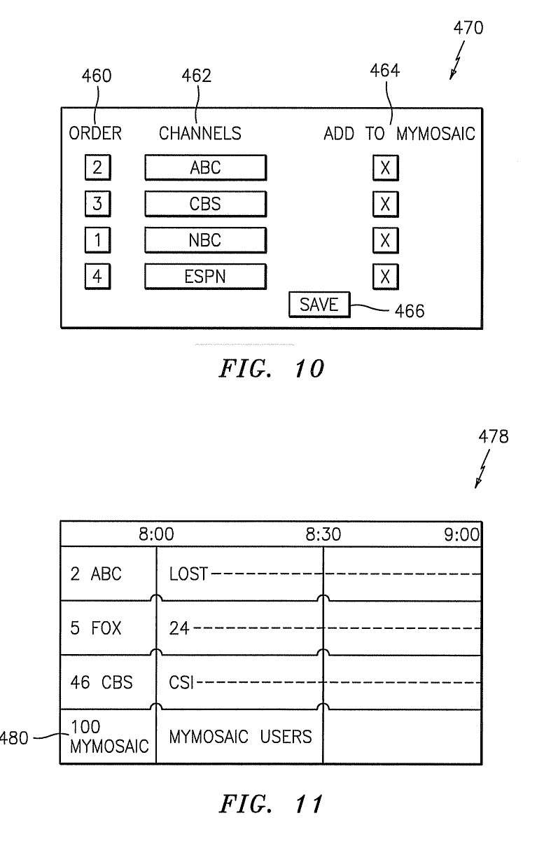

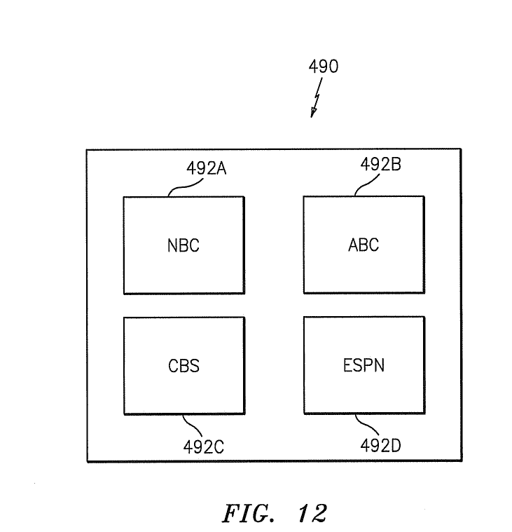

FIG. 9 is a flow diagram illustrating a process for implementing the personalized composite content services in exemplary embodiments. A user interface screen 470 for creating a composite media channel is shown in FIG. 10. This screen 470 may be presented to the user on the display screen of the media device 402 via, e.g., an electronic programming guide. As shown in the user interface screen 470 of FIG. 10, the user enters the channel selections from a channel selection column 462 and a column 464. Once completed, the user selects a SAVE option 466.

At step 440, the composite media application receives the channel selections from the user of the media device 402. The channels are distributed as video broadcast streams transmitted by a video broadcast source, such as one of the content sources 416A-416n. At step 442, a composite media channel record is created for the user. The composite media channel record contains various fields for storing information. For example, the composite media channel record may contain fields for identifying a broadcast channel content stream (e.g., the channel selected) and/or user identification of the user. At step 444, the composite media application stores the content stream identifier for each of the selected channels, as well as the user identifier in the composite media channel record. The user identification may be implemented in a similar manner as that described above in FIG. 2 (e.g., authentication process including combined device identifier and PIN code). Once completed, the resulting composite media channel may be displayed as an independent channel on the user's electronic programming guide. As shown in FIG. 11, an electronic programming guide illustrated on a display screen 478 includes a newly-created composite media channel 480 in the EPG.

At step 446, the composite media application receives a request from the user to access a composite media channel, such as the composite media channel 480. This may be implemented, e.g., by selecting the composite media channel 480 listed in the EPG via the display screen 478. At step 448, the composite media application retrieves the composite media channel record for the composite media channel 480. At step 450, the composite media application populates picture-in-picture (PIP) panels of the media device display screen with content streams associated with content stream identifiers for the channel selections associated with the composite media channel 480. FIG. 12 illustrates a display screen 490 of the media device 402 and includes four PIP panels 492A through 492D. Each of the panels 492A-492D are linked to corresponding content stream identifiers for the channel selections associated with the composite media channel 480, and each of the panels 492A-492D simultaneously displays video streams associated with the content stream identifiers.

Another feature of the composite media application includes allowing the user to select an order in which the content video streams are displayed on the display device of the media device 402. This may be implemented via an ORDER column 460 shown in FIG. 10. For example, as shown in FIG. 10, the user has selected the order of NBC, ABC, CBS, and ESPN. Thus, as shown in FIG. 12, the ordering of the video content streams provided by the ORDER column 460 is applied to the PIP panels 492A-492D. In addition, this ordering may be modified, either directly by the user (e.g., via the ORDER column 460; that is, re-ordering), or the ordering may be modified automatically by the composite media application. For example, the composite media application may monitor the frequency in which the content streams are actively viewed by the user of the media device. Those video streams determined to be more frequently viewed are re-ordered at or near the top of the order list, and the PIP panels 492A-492D are populated accordingly. Active viewing of the video streams may be determined as the viewer scrolls or highlights each of the PIP panels 492A-492D, indicating that the highlighted panel is the panel that is actively viewed. In addition, once the user highlights a PIP panel, a corresponding audio file for the video content stream is presented on the media device. This is another indicator that the viewer prefers one video stream to another video stream.

In exemplary embodiments, the composite media application enables the user to select multiple video broadcast streams for simultaneous viewing. If the viewer is configuring a composite media channel, such as the composite media channel 480, for a large-screen television, the composite media application enables the user to select a greater number of video broadcast streams to be simultaneously displayed on the display screen. However, if the user is configuring the composite media channel 480 for a smaller television screen, too many PIP panels, which are decreased in size to fit the screen, may not benefit the viewer. The composite media application enables the viewer to create multiple scrollable PIP pages, with each page containing a number of PIP panels. In this manner, the user may scroll from page to page using, e.g., control functions established by the composite media application through the input device 412. The user may also configure the ordering of the PIP panels for each page as described above.

The viewing activities of the user may be tracked in a log file. The log file may contain, e.g., the user identification information, the channels viewed by the user, and the time of viewing. The log file may be distributed by the composite media application to an external entity, such as the service provider system 406 for analysis. Alternatively, or additionally, the log file may be stored in the STB 410 of the media device 402 and displayed to the user upon request.

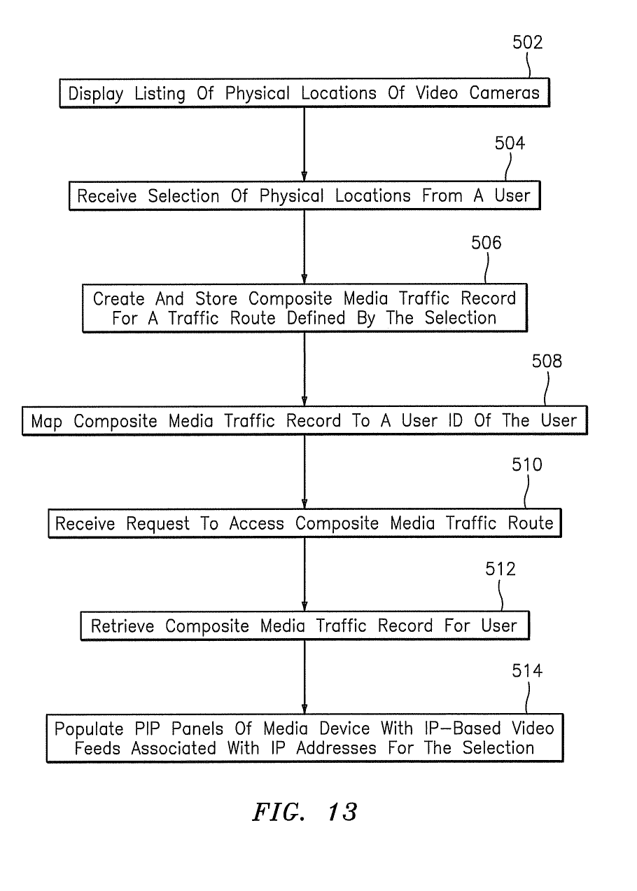

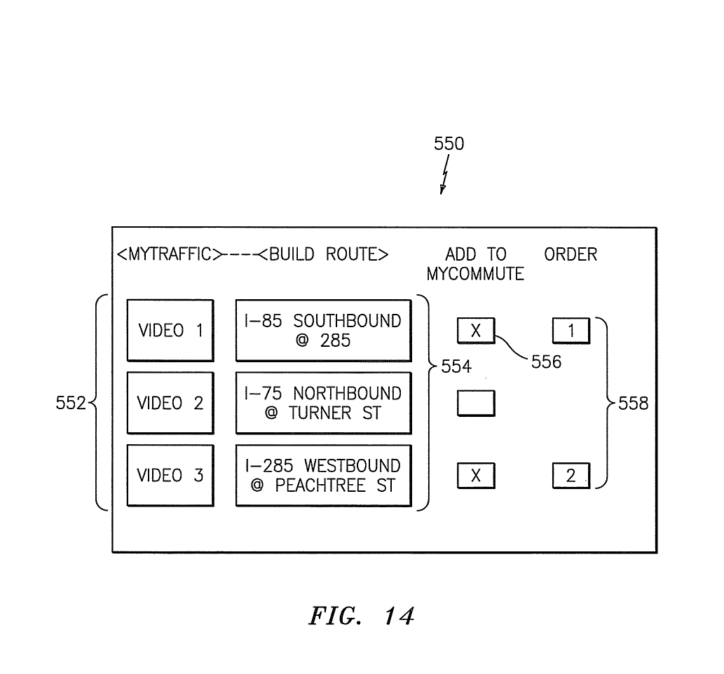

FIG. 13 is a flow diagram describing a process for implementing the personalized electronic traffic reporting services in exemplary embodiments. A user interface screen 550 for creating a personalized electronic traffic report is shown in FIG. 14. This screen 550 may be presented to the user on the display screen of the media device 402 via, e.g., an electronic programming guide or by direct access of the traffic application on the STB 410. According to exemplary embodiments, the personalized electronic traffic reporting services provide IP-enabled video cameras (e.g., one or more of the content sources 416A-416n) to feed live video data to the media device 402 as configured by the user. At step 502, the traffic application displays a listing of physical locations of Internet Protocol-enabled video cameras. As shown in the display screen 550 of FIG. 14, video options 552 are associated with IP-enabled video cameras and physical locations in which the video cameras are disposed. Physical location options 554 are reflected in the display screen 550. Each of the IP-enabled video cameras may be assigned an address (e.g., uniform resource locator (URL)). At step 504, the traffic application receives a selection of physical locations from a user (e.g., via the options 554 and the 556 of FIG. 14).

At step 506, the traffic application creates and stores a composite media traffic record for a traffic route defined by the selection. At step 508, the composite media traffic record is mapped to a user identifier of the user. The user identification may be implemented in a similar manner as that described above in FIG. 2 (e.g., authentication process including combined device identifier and PIN code). At step 510, the traffic application receives a request to access a composite media traffic route. At step 512, the traffic application retrieves the composite media traffic record for the user. At step 514, PIP panels of the media device 402 display screen are populated with IP-based video feeds associated with the IP address for the selection. The PIP panels on the display screen may be configured similar to those described in FIG. 12 with respect to the composite media channel services.

Another feature of the traffic application includes allowing the user to select an order in which the video camera streams are displayed on the display device of the media device 402. This may be implemented via an ORDER column 558 shown in FIG. 14. For example, as shown in FIG. 14, the user has selected the order of VIDEO 1 followed by VIDEO 3. In addition, this ordering may be modified, either directly by the user (e.g., via the ORDER column 558; that is, re-ordering), or the ordering may be modified automatically by the traffic application. For example, the traffic application may monitor the frequency in which the video camera streams are actively viewed by the user of the media device 402. Those video streams determined to be more frequently viewed are re-ordered at or near the top of the order list, and the PIP panels are populated accordingly. Active viewing of the video streams may be determined as the viewer scrolls or highlights each PIP panel, indicating that the highlighted panel is the panel that is actively viewed. In addition, once the user highlights a PIP panel, the highlighted PIP panel may be increased in size as compared to the remaining panels. This is another indicator that the viewer prefers one video stream to another video stream.

In exemplary embodiments, the traffic application enables the user to select multiple video camera streams for simultaneous viewing (e.g., one traffic route may include three separate physical locations that define a route). If the viewer is configuring an electronic traffic report for a large-screen television, the traffic application enables the user to select a greater number of video camera streams to be simultaneously displayed on the display screen. However, if the user is configuring an electronic traffic report for a smaller television screen, too many PIP panels, which are decreased in size to fit the screen, may not benefit the viewer. The traffic application enables the viewer to create multiple scrollable PIP pages, with each page containing a number of PIP panels (e.g., when configuring multiple traffic routes). In this manner, the user may scroll from page to page using, e.g., control functions established by the traffic application through the input device 412.

In an exemplary embodiment, additional information may be included in the electronic traffic report. For example, one of the content sources 416A-416n may provide an RSS text feed that describes or supplements the traffic conditions existing at the time the video stream is transmitted.

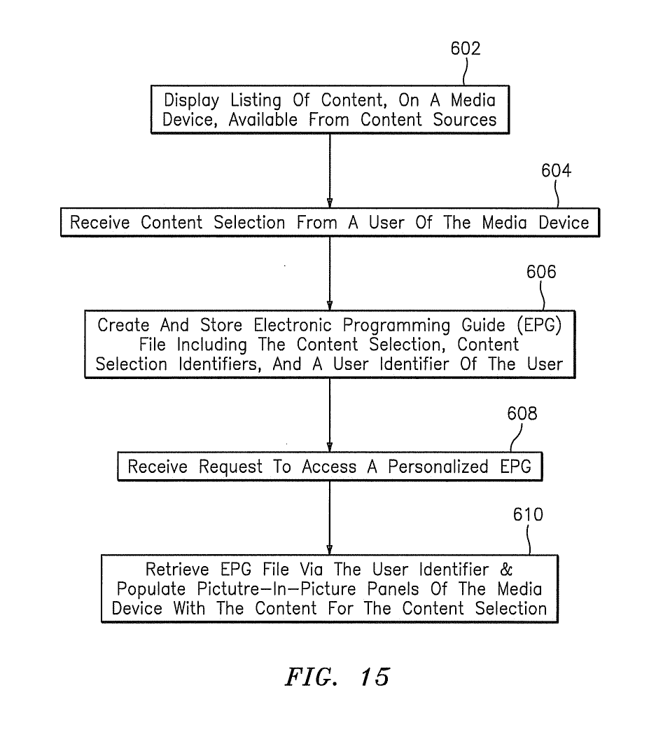

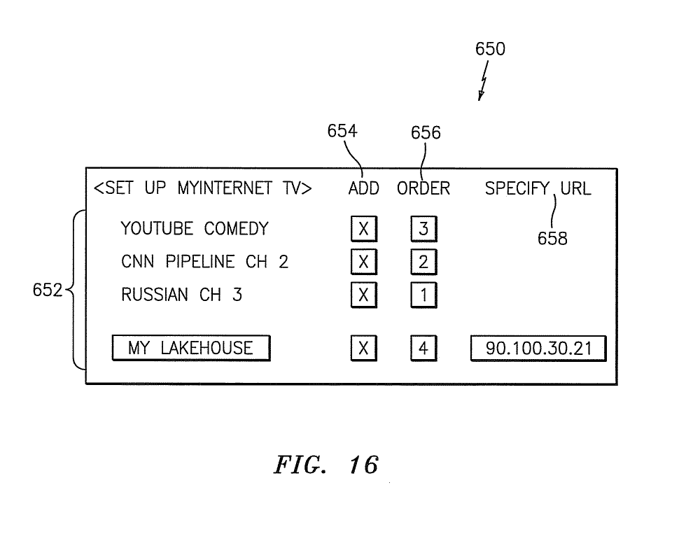

FIG. 15 is a flow diagram describing a process for implementing the personalized electronic programming guide (EPG) services in exemplary embodiments. A user interface screen 650 for creating a personalized EPG is shown in FIG. 16. This screen 650 may be presented to the user on the display screen of the media device 402 via, e.g., an existing electronic programming guide or by direct access of the programming guide application on the STB 410. The personalized EPG services enable a user to select content from a variety of different sources for creating a customized programming guide. For example, content sources may include IP-based video content, IP-based radio content, and non-commercial IP-based content sources. Non-commercial IP-based content sources may include a personal Internet Protocol-enabled video camera, digital video disc (DVD) player, or other non-commerce content sources. The programming guide application provides IP-enabled content sources (e.g., one or more of the content sources 416A-416n) to feed live or recorded video data to the media device 402 as configured by the user.

At step 602, the programming guide application displays a listing of content on the media device 402 that is available from the various content sources 416a-416n. As shown in FIG. 16, the display screen 650 lists content 652 available from the content sources 416A-416n. The user selections are made via column 654, and the ordering thereof may be implemented via a column 656 in a manner similar to that described above in FIGS. 9 and 13. If the content is personal or non-commercial content, the display screen 650 includes data fields for entering a description of the content (via the column 652) and an address 658 (e.g., URL) of the content.

At step 604, the programming guide application receives the content selection from a user of the media device 402. At step 606, the programming guide application creates and stores electronic programming guide (EPG) file including the content selection, content selection identifiers, and a user identifier of the user. The user identification may be implemented in a similar manner as that described above in FIG. 2 (e.g., authentication process including combined device identifier and PIN code). If the content is provided by a video broadcast service provider, the content selection identifier may be a content stream identifier. If the content is provided by an IP-based content source, such as IP-based video, radio, or non-commercial source, then the content selection identifier may be a URL of the content. The non-commercial video content may include a live video stream or a pre-recorded video stream. At step 608, the programming guide application receives a request to access a personalized EPG. At step 610, the programming guide application retrieves the EPG file via the user identifier and populates PIP panels of the media device 402 with the content for the content selection. The PIP panels may be implemented in a similar manner to those described above in FIG. 12.

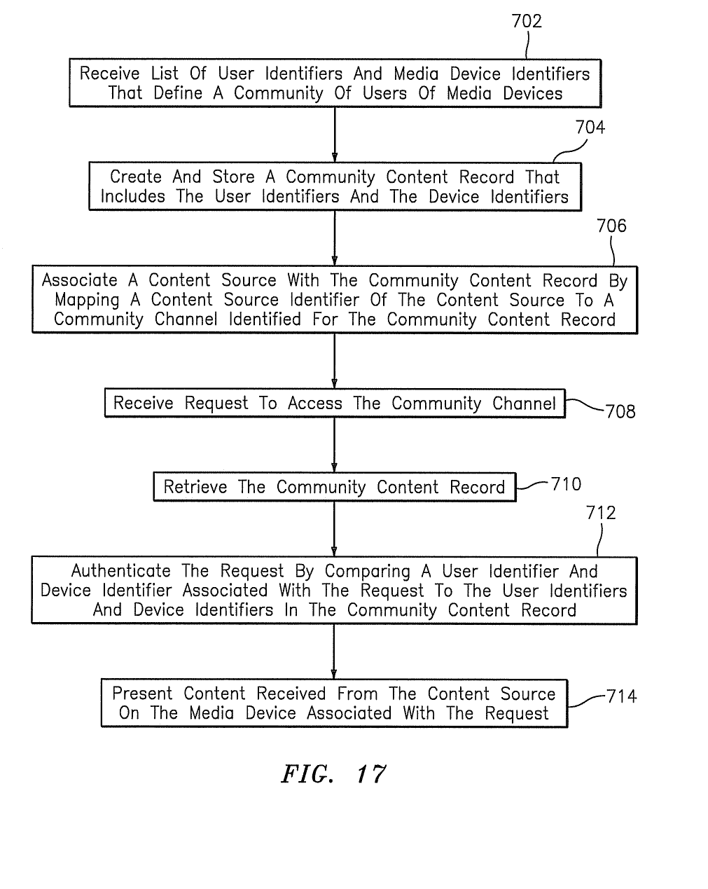

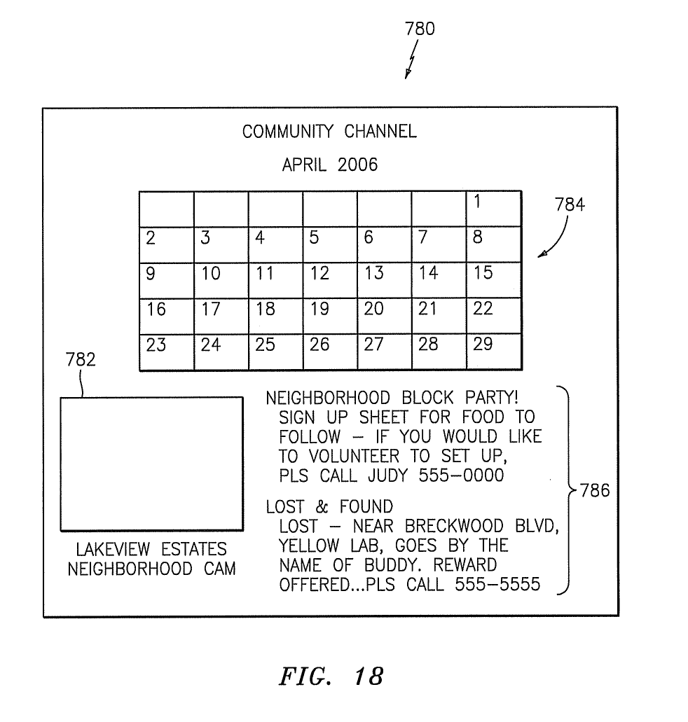

FIG. 17 is a flow diagram describing a process for implementing the customized communications channel services in exemplary embodiments. At step 702, the custom communication application receives a list of user identifiers and media device identifiers that define a community of users of media devices. For example, a community of users may be a residential neighborhood or homeowners association, an organization, such as a church, a sports league, a government entity, etc. At step 704 the custom communication application creates and stores a community content record that includes the user identifiers and the device identifiers. At step 706, the custom communication application associates a content source with the community content record by mapping a content source identifier of the content source to a community channel identified for the community content record. In one exemplary embodiment, the community is a residential neighborhood and the content source is a neighborhood IP-enabled video camera placed in the neighborhood (e.g., serving as a community crime watch service). At step 708, the custom communication application receives a request to access the community channel. At step 710, the custom communication application retrieves the community content record. At step 712, the custom communication application authenticates the request by comparing a user identifier and device identifier associated with the request to the user identifiers and device identifiers in the community content record. The user identification may be implemented in a similar manner as that described above in FIG. 2 (e.g., authentication process including combined device identifier and PIN code). Once completed, the resulting community channel may be displayed as an independent channel on the user's electronic programming guide. As shown in FIG. 18, a display screen 780 includes the newly created community channel.

At step 714, the custom communication application presents content received from the content source on the media device 402 associated with the request. FIG. 18 is a display screen 780 illustrating a sample customized communications channel in exemplary embodiments. As shown in FIG. 18, the display screen 780 includes a PIP panel 782 that is associated with the video stream transmitted by the selected content source (e.g., neighborhood watch video camera). In addition to the video stream, various additional media files may be selected by the user for inclusion in the customized communications channel. For example, a community calendar (e.g., a calendar 784) may be added whereby the user may provide neighborhood, or community-related information about upcoming events. Various text files 786 may be added that are of interest or related to the community of users. Other information may include advertising (e.g., local businesses, etc.).

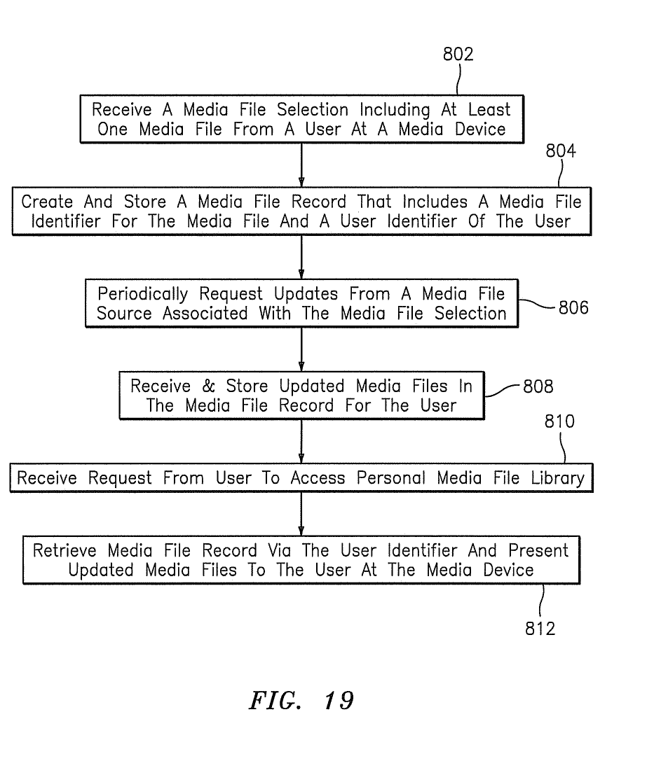

FIG. 19 is a flow diagram describing a process for implementing the personalized media file library services in accordance with exemplary embodiments. At step 802, the media application receives a media file selection including at least one media file from a user at the media device 402. The media files originate from one or more of the content sources 416A-416n and may include, e.g., podcast media service providers. At step 804, the media application creates and stores a media file record that includes a media file identifier for the media file (e.g., podcast) and a user identifier of the user. At step 806, the media application periodically requests updates from a media file source associated with the media file selection. At step 808, the media application receives and stores updated media files in the media file record for the user. At step 810, the media application receives a request from the user to access a personal media file library. At step 812, the media application retrieves a media file record via the user identifier and presents updated media files to the user at the media device.

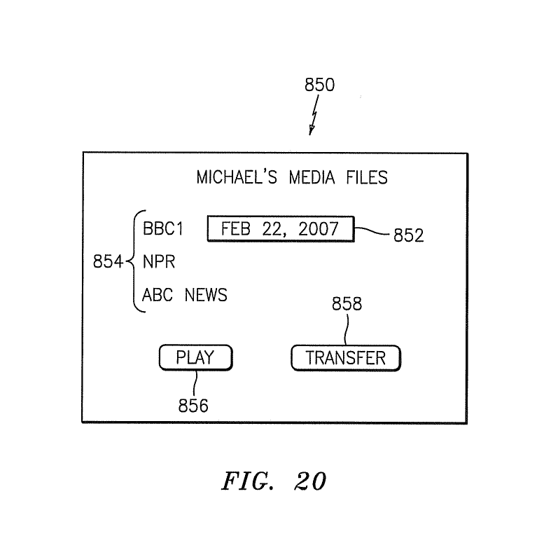

FIG. 20 is a display screen illustrating a sample personalized media file library in exemplary embodiments. The display screen 850 lists selected media files 854 and any updates 852 available to the media file sources. A user may select a PLAY option 856 to open the media file, or may select a TRANSFER option 858 in order to transfer the media file to another device, e.g., media device 418 of FIG. 8.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments execute specific microprocessor machine instructions. The computer program product code could also be implemented using electronic logic circuits or a microchip.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for implementing electronic transactions, comprising:
receiving log-in credentials and addressing data for an electronic commerce website;
assigning a combined device identifier and personal information number (PIN) code to an account record, the combined device identifier and PIN code uniquely identifying an individual associated with the log-in credentials;
mapping the combined device identifier and PIN code to the log-in credentials within the account record;
in response to receiving a request for information, searching the electronic commerce website for data matching an element of the request; and
presenting results of the search to a device associated with the device identifier.

2. The method of claim 1, further comprising:
sending a prompt for the PIN code in response to a request to initiate a purchase for an item found in the results of the search;
identifying the log-in credentials mapped to the combined device and the PIN code received in response to the prompt;
authenticating the log-in credentials;
logging into the electronic commerce website using the log-in credentials when results of the authenticating meet specified authentication criteria;
displaying on the device purchase information for the item, the purchase information retrieved from the electronic commerce website; and
executing the purchase.

3. The method of claim 2, wherein the item is an electronic media file, the purchase information includes payment options, and executing the purchase includes acquiring payment data via the payment options and downloading the electronic media file.

4. The method of claim 3, wherein executing the purchase further includes selecting a device to which the electronic media file is downloaded.

5. The method of claim 2, wherein the item is a tangible product, the purchase information includes payment options and shipping data, and executing the purchase includes acquiring payment data via the payment options and transmitting a purchase order including the purchase information, payment data, and shipping data to the electronic commerce website.

6. The method of claim 2, further comprises:
assigning an account value to the combined device identifier and PIN code; wherein executing the purchase further includes modifying the account value commensurate with the cost of the item, and storing the modified account value in the account record.

7. The method of claim 1, wherein the device identifier is a globally unique identifier assigned to the device at the time of manufacture; wherein assigning the combined device identifier and PIN code to an account record includes retrieving the globally unique identifier from the device.

8. A method for implementing event-driven marketing activities, comprising:
detecting a device that is tuned into an interactive channel by a viewer at the device;
determining an item for sale from a source location based upon items associated with the interactive channel and at least one of an identity of the viewer and viewing activities conducted by the viewer at the device;
displaying the determined item for sale on the device; and
executing a purchase for the determined item upon receiving an acceptance by the viewer via the device to purchase the determined item.

9. A method for implementing a personalized, composite media channel, comprising:
receiving a channel selection comprising at least one channel from a user of a media device, the at least one channel including a content stream identifier;
creating a composite media channel record for the user and storing the content stream identifier and a user identifier of the user in the composite media channel record; and
in response to a request to access a composite media channel, retrieving the composite media channel record of the composite media channel for the user and populating picture-in-picture panels of the media device with content streams associated with the content stream identifier for the channel selection.

10. A method for implementing a personalized electronic traffic report, comprising:
displaying a listing, on a media device, of physical locations in which video cameras are present, the physical locations mapped to Internet Protocol addresses assigned to the video cameras;
receiving a selection of the physical locations from a user at the media device, the selection defining a traffic route;
creating and storing a composite media traffic record for the traffic route;
mapping the composite media traffic record to a user identifier of the user; and
in response to a request to access a composite media traffic route, retrieving the composite media traffic record for the user based upon the user identifier, and populating picture-in-picture panels of the media device with live Internet Protocol-based video feeds associated with the Internet Protocol addresses for the selection.

11. The method of claim 10, further comprising:
creating multiple scrollable picture-in-picture panel pages, wherein each of the multiple pages includes a number of picture-in-picture panels displaying corresponding Internet Protocol-based video feeds associated with corresponding Internet Protocol addresses for the selection.

12. The method of claim 10, wherein populating picture-in-picture panels of the media device includes displaying the live Internet Protocol-based video feeds in an order selected by the user of the media device.

13. The method of claim 12, further comprising:
modifying the order in which the live Internet Protocol-based video feeds are displayed in response to at least one of:
re-ordering of the live Internet Protocol-based video feeds by user request; and
automated re-ordering of the live Internet Protocol-based video feeds based upon a frequency in which the live Internet Protocol-based video feeds are actively viewed by the user of the media device.

14. The method of claim 13, further comprising:
monitoring the frequency in which the live Internet Protocol-based video feeds are actively viewed by the user of the media device, wherein active viewing of a live Internet Protocol-based video feeds includes highlighting one of the picture-in-picture panels for the live Internet Protocol-based video feeds, the highlighting causing the highlighted picture-in-picture panel to increase in size commensurate with a screen size of a display of the media device.

15. The method of claim 10, further comprising:
storing the composite media traffic record in an electronic programming guide file, wherein the request to access the composite media traffic route of the composite media traffic record is implemented via the electronic programming guide file.

16. The method of claim 10, further comprising:
associating each of the live Internet Protocol-based video feeds with a text media feed, the text media feed including supplemental traffic information relating to events at physical location of the corresponding video camera.

17. A method for implementing a personalized media file library, comprising:
receiving a media file selection including at least one media file from a user at a media device;
creating and storing a media file record that includes a media file identifier for the media file and a user identifier of the user;
periodically requesting updates from a media file source associated with the media file selection;
receiving and storing updated media files in the media file record for the user; and
in response to receiving a request from the user to access a personal media file library, retrieving the media file record via the user identifier and presenting updated media files to the user at the media device.

18. A method for implementing a personalized electronic programming guide (EPG), comprising:
displaying a listing of content available on a media device, the content provided by content sources including at least one of: a video broadcast service provider, an Internet Protocol-based video content service provider, and Internet Protocol-based radio content service provider, and a non-commercial, Internet Protocol-based content source;
receiving a content selection from a user of the media device via the listing of content;
creating and storing a personalized electronic programming guide (EPG) file that includes the content selection, content selection identifiers, and a user identifier of the user; and
in response to a request to access the personalized EPG, retrieving the personalized EPG via the user identifier, and populating picture-in-picture panels of the media device with the content for the content selection.

19. The method of claim 18, wherein:
the content identifier of the content provided by the video broadcast service provider includes a content stream identifier; and
the content identifier of the content provided by the Internet Protocol-based video content service provider, Internet Protocol-based radio content service provider, and non-commercial Internet Protocol-based content source includes a uniform resource locator.

20. The method of claim 19, wherein the non-commercial Internet-based content source is a video stream received from an Internet Protocol-enabled video camera.
